(19) United States
(12) Patent Application Publication
(10) Pub. No.: US 2015/0026626 A1
(43) Pub. Date: Jan. 22, 2015

(54) SOFTWARE KEYBOARD INPUT DEVICE, INPUT METHOD AND ELECTRONIC APPARATUS

(71) Applicant: ROHM CO., LTD., Kyoto (JP)

(72) Inventors: Atsushi YOKOYAMA, Kyoto (JP); Hirotoshi USUI, Kyoto (JP)

(21) Appl. No.: 14/336,030

(22) Filed: Jul. 21, 2014

(30) Foreign Application Priority Data
Jul. 22, 2013 (JP) 2013-152048

(51) Int. Cl. G06F 3/0488; G06F 3/0484

(52) U.S. Cl. CPC G06F 3/04886; G06F 3/04842
USPC 715/773

(57) ABSTRACT

An input method using a software keyboard, includes: displaying a software keyboard on a display device having a touch panel; monitoring an input from a user and detecting a sequence including input of an original character string, deletion of some or all of the original character string and re-input of a new character string; acquiring at least one of an incorrect input character contained in the original character string and a corresponding correct input character contained in the new character string; and correcting the software keyboard based on the incorrect input character and the correct input character.

### CROSS-REFERENCE TO RELATED APPLICATIONS

This application is based upon and claims the benefit of priority from Japanese Patent Applications No. 2013-152048, filed on Jul. 22, 2013, the entire contents of which are incorporated herein by reference.

### TECHNICAL FIELD

The present disclosure relates to a software keyboard.

### BACKGROUND

Many electronic devices, such as tablet terminals, smartphones and so on, have no hardware keyboard. Such electronic devices are adapted to display a software keyboard on a touch panel and receive operation inputs from a user through the software keyboard.

A QWERTY type hardware keyboard has keys corresponding to left and right index fingers, i.e., F and K keys, or keys corresponding to left and right middle fingers, i.e., D and K keys, both of which are provided with projections to allow a user to confirm a home position easily. On the other hand, in a software keyboard, since a liquid crystal display panel cannot be provided with projections, it is difficult to determine a home position without seeing the software keyboard with naked eyes. Further, in such electronic devices, since an area of the software keyboard is limited by the size of the liquid crystal display panel, the size of the software keyboard is often smaller than that of the hardware keyboard. Under such circumstances, it is hard to say that the electronic devices having such a software keyboard can provide the user with more comfortable input environments comparable to hardware keyboards.

There have been proposed some techniques for providing the user with more comfortable input environments in electronic devices having a software keyboard.

### SUMMARY

The present disclosure provides some embodiments of a software keyboard input device and method which are capable of providing comfortable input environments with a new approach different from those known in the art.

According to one embodiment of the present disclosure, there is provided an input device using a software keyboard, including: a display device having a touch panel; a coordinate detecting unit configured to generate coordinate data indicating positions on the touch panel touched by a user; a keyboard displaying unit configured to display a software keyboard on the display device; an input determining unit configured to generate a code in response to a key touched by the user based on layout information of the software keyboard currently displayed on the display device and the coordinate data; and a keyboard correcting unit configured to correct the software keyboard by monitoring the code. The keyboard correcting unit includes: a re-input detector configured to monitor the code and detect a sequence including input of an original character string, a command to delete at least one character of the original character string and a re-input of a new character string similar to the original character string; an incorrect input character estimator configured to acquire at least one of an incorrect input character contained in the original character string and a corresponding correct input character contained in the new character string from comparison between the original character string and the new character string; and a correction executer configured to correct the software keyboard based on the acquired at least one of the incorrect input character and the correct input character.

With this configuration, by detecting an incorrect input from a user and correcting the software keyboard in response to an error in character string received from the user, it is possible to learn a user's hand size and finger length or a user's habit, thereby optimizing an array of the software keyboard adaptively and realizing more comfortable input environments for the user.

The correction executer may correct the size of at least one key of the software keyboard.

The correction executer may enlarge the size of a key corresponding to the correct input character. By enlarging the size of a key hard to be pressed, it is possible to easily press the key after the correction.

The correction executer may reduce the size of a key corresponding to the incorrect input character. By reducing the size of a key which is likely to be pressed by mistake, it is possible to prevent the key from being pressed by mistake after the correction.

The correction executer may enlarge the size of a key corresponding to the correct input character if the incorrect input character is null and the correct input character is a character.

The correction executer may enlarge the size of a key corresponding to the incorrect input character if the incorrect input character is a character and the correct input character is null. In particular, the correction executer may reduce the size of the key corresponding to the incorrect input character if a key corresponding to a character located before or after the incorrect input character of the original character string is adjacent to the key corresponding to the incorrect input character on the keyboard.

The keyboard correcting unit may correct the software keyboard if the key corresponding to the incorrect input character and the key corresponding to the correct input character are both characters and are adjacent to each other on the software keyboard. The keyboard correcting unit may reduce the size of the key corresponding to the incorrect input character and enlarge the size of the key corresponding to the correct input character.

The correction executer may correct a position of at least one key of the software keyboard.

The correction executer may shift the key corresponding to the correct input character toward the key corresponding to the incorrect input character.

The keyboard correcting unit may further include: a success rate calculator configured to calculate a typing success rate. The correction executer may restore the software keyboard to a state before the correction if the success rate is decreased after the software keyboard is corrected. That is, as the previous correction to the software keyboard did not necessarily lead to an improvement of the software keyboard, the software keyboard is restored to the original state before the correction. In this embodiment, it is possible to prevent a success rate from being decreased due to excessive or inappropriate correction.

The input device may further include an initial setting unit configured to perform initial setting of the software keyboard. The initial setting unit may perform a sequence including: registering a plurality of fingers used for initial setting of the software keyboard in the left and right hands and a plurality of keys corresponding to the plurality of fingers, based on an input from the user; displaying a finger recognition frame in a region where the software keyboard of the display device is to be displayed; urging for the user to touch the finger recognition frame with the plurality of fingers in a state where the hands of the user are aligned on the home position of the user and detecting coordinates of the plurality of fingers touched by the user; and determining an initial arrangement of the software keyboard based on the coordinates of the plurality of fingers touched by the user.

The input device may further include a customization unit configured to switch any two keys designated by the user.

The input device may further include a macro unit configured to assign any character string designated by the user to a corresponding key.

According to another embodiment of the present disclosure, there is provided an electronic apparatus including the above-described input device.

Any combinations of the above-described elements or changes of the representations of the present disclosure between methods and apparatuses are effective as embodiments of the present disclosure.

### BRIEF DESCRIPTION OF THE DRAWINGS

FIG. 1 is a block diagram of an input device according to an embodiment.

FIG. 2 is a flow chart showing processing performed by a re-input detector and an incorrect input character estimator of the input device of FIG. 1.

FIG. 3 is a flow chart showing processing performed by a correction executer.

FIGS. 4A to 4C are views showing states where keys are corrected in steps S204, S210 and S214 in FIG. 3, respectively.

FIG. 5 is a flow chart of an initialization sequence of a software keyboard.

FIG. 6A is a view showing a finger recognition frame, FIG. 6B is a view showing a state where the finger recognition frame is touched by a user, and FIG. 6C is a view showing a software keyboard calculated from finger coordinates.

### DETAILED DESCRIPTION

Some embodiments of the present disclosure will now be described in detail with reference to the drawings. Throughout the drawings, the same or similar elements, members and processes are denoted by the same reference numerals and explanation of which will not be repeated. The disclosed embodiments are provided for the purpose of illustration of the present disclosure, and the present disclosure is not limited to the features and combinations thereof described in the embodiments of the present disclosure and the embodiments alone cannot be necessarily construed to describe the spirit of the present disclosure.

In the present disclosure, the phrase “a connection of a member A and a member B” is intended to include a direct physical connection of the member A and the member B as well as an indirect connection thereof via other member as long as the other member has no substantial effect on the electrical connection of the member A and the member B or has no damage to functions and effects shown by a combination of the member A and the member B. Similarly, the phrase “an interposition of a member C between a member A and a member B” is intended to include a direct connection of the member A and the member C or a direct connection of the member B and the member C as well as an indirect connection thereof via other member as long as the other member has no substantial effect on the electrical connection of the member A, the member B and the member C or has no damage to functions and effects shown by a combination of the member A, the member B and the member C.

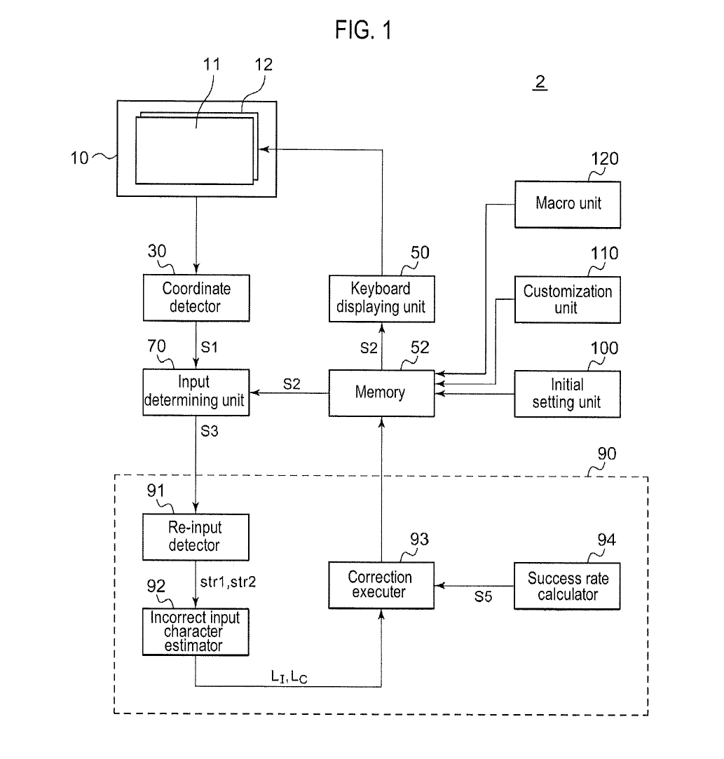

FIG. 1 is a block diagram of an input device 2 according to an embodiment of the present disclosure. The input device 2 includes a display unit 10, a coordinate detecting unit 30, a keyboard displaying unit 50, an input determining unit 70 and a keyboard correcting unit 90.

The display unit 10 includes a touch panel 11 and a display panel 12. The coordinate detecting unit 30 is connected to the touch panel 11 and generates coordinate data 51 indicating a coordinate on the touch panel 11 touched by a user.

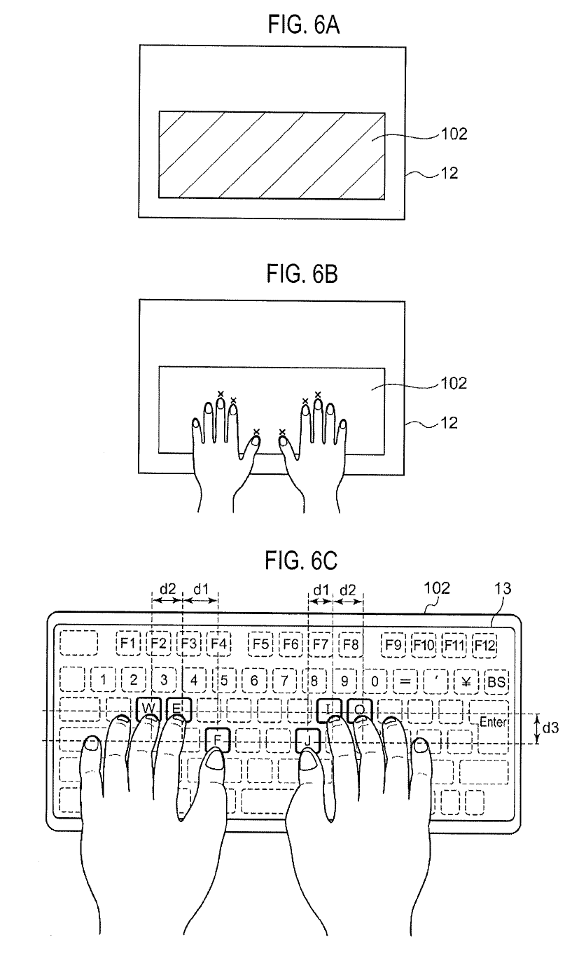

The keyboard displaying unit 50 is connected to the display panel 12. Layout data S2 indicating a layout of keys constituting a software keyboard 13 (see FIG. 6C) are stored in a memory 52. A data structure of the layout data S2 is not particularly limited but may include, for example, (i) coordinates of four vertices of a rectangle or (ii) a coordinate of one vertex and vertical and horizontal lengths of each key. The keyboard displaying unit 50 displays the software keyboard 13 on the display panel 12 of the display unit 10 based on the layout data S2.

The input determining unit 70 generates a code S3 in response to a key touched by the user based on the layout data S2, which indicates an array of the software keyboard 13 displayed on the display panel 12 of the display unit 10, and the coordinate data S1.

The keyboard correcting unit 90 monitors the code S3 and corrects the layout data S2 of the software keyboard 13 stored in the memory 52 based on a result of the monitoring. The code S3 may be a key code or a character code allocated to each key. In the following description, for the purpose of simplifying and easy understanding of the description, it is assumed that the code S3 is the character code.

The keyboard correcting unit 90 includes a re-input detector 91, an incorrect input character estimator 92 and a correction executer 93.

The re-input detector 91 monitors the code S3 and searches a series of sequences including an input of an original character string str1, a subsequent deletion of some or all of the original character string str1 and a subsequent re-input of a new character string str2 similar to the original character string str1. The incorrect input character estimator 92 estimates an incorrect input character L_{I} and a correct input character L_{C} by comparing the original character string str1 and the new character string str2.

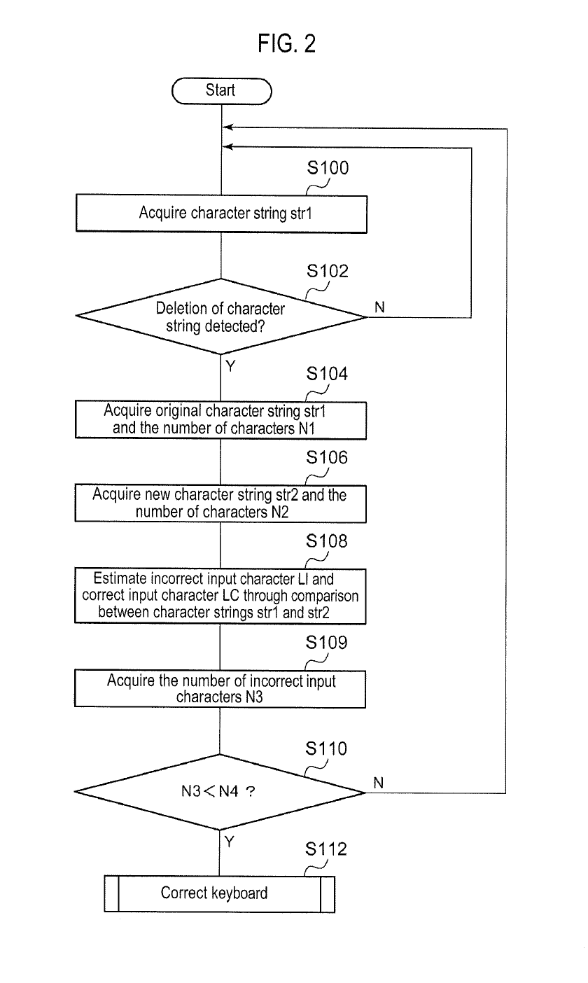

FIG. 2 is a flow chart showing processing performed by the re-input detector 91 and the incorrect input character estimator 92 of the input device of FIG. 1.

The re-input detector 91 stores a character string str1 as a sequence of the code S3 in a buffer (S100). Then, if a command to delete the character string str1, i.e., pressing of “Delete key” or “Backspace key”, is not detected (N in S102), the character string str1 is updated. If a command to delete some or all of the character string str1 is detected (Y in S102), the original character string str1 and the number of characters N1 of the original character string str1 are stored (S104).

Subsequently, a new character string str2 that includes characters input after detecting the command to delete some or all of the character string str1 and the number of characters N2 of the new character string str2 are stored (S106).

Then, the original character string str1 is compared with the new character string str2 and a character (incorrect input character) L_{I} which is likely to be the first incorrect input and a character (correct input character) L_{C} which is likely to be the correct input after the re-input are acquired (S108). The incorrect input character L_{I} and the correct input character L_{C} may be “Null” or no input. For example, where “Hello” is to be input, if “Hllo” is input, the incorrect input character L_{I} is “Null” and the correct input character L_{C} is “e”. As another example, where “Hello” is to be input, if “Helljo” is input, the incorrect input character L_{I} is “j” and the correct input character L_{C} is “Null”.

In some case, the character strings str1 and str2 may contain two or more incorrect characters. In this case, an incorrect input array A_{I} storing incorrect input characters L_{I} and a correct input array A_{C} storing correct input characters L_{C} are prepared. Thus, the number of characters N3 of the incorrect input characters L_{I} is also acquired (S109).

For example, if the number of characters N3 of the incorrect input characters L_{I} is 2, two incorrect characters are respectively stored in the first and second elements L_{I}[0] and L_{I}[1] of the incorrect input array A_{I}and two correct characters are respectively stored in the first and second elements L_{C}[0] and L_{C}[1] of the correct input array A_{C}.

If the number of characters N3 of the incorrect input characters L_{I} is larger than a threshold N4 (N in S110), it is assumed that this is not a typographical error but a change of a sentence and the process returns to the step S100 without performing a correction method of the software keyboard 13.

Conversely, if the number of characters N3 of the incorrect input characters L_{I} is smaller than the threshold N4 (Y in S110), this is highly likely to be a typographical error and a correction method of the software keyboard 13 is accordingly performed (S112).

Here, the threshold N4 may be a value obtained by multiplying the number of characters N1 of the original character string str1 by a predetermined coefficient k.

N4=N1×k

For example, k=0.5. Sensitivity of the correction of the software keyboard 13 may be adjusted by optimizing this parameter k.

Returning to FIG. 1, the correction executer 93 corrects the software keyboard 13 based on at least one of the incorrect input character L_{I} and the correct input character L_{C}.

The correction executer 93 corrects a size of at least one key of the software keyboard 13. More specifically, the correction executer 93 enlarges a key K_{C} corresponding to the re-input correct input character L_{C} and/or reduces a key K_{I} corresponding to the incorrect input character L_{I}.

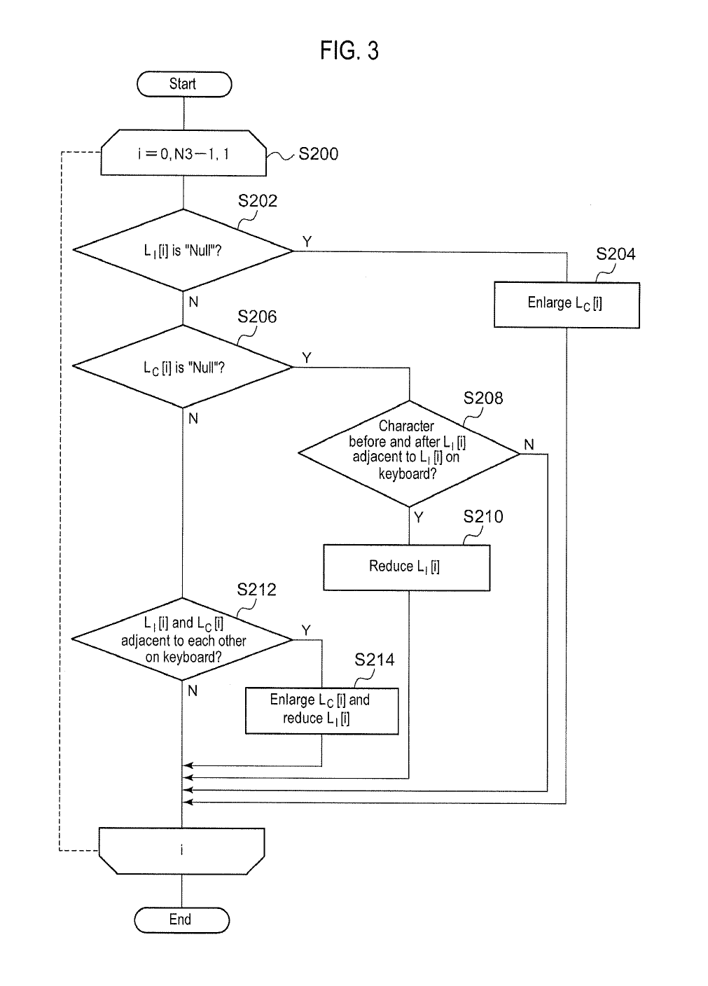

FIG. 3 is a flow chart showing a process performed by the correction executer 93. The correction executer 93 performs the process sequentially while incrementing a variable i for all of N3 incorrect input characters L_{I} and N3 correct input characters L_{C} included in the arrays A_{C} and A_{I}, respectively (S200).

If an i-th element L_{I}[i] of the incorrect input array A_{I} is null (Y in S202), the correction executer 93 enlarges K_{C} corresponding to L_{C}[i] (S204).

At this time, a key K_{A} adjacent to L_{C}[i] can be reduced. For example, if m keys K_{A} are adjacent to the key K_{C}, the m keys K_{A} can be reduced. Thus, the size of the software keyboard 13 may be maintained.

If an incorrect input character L_{I}[i] is non-null (N in S202) and a correct input character L_{C}[i] is null (Y in S206), the correction executer 93 reduces a key K_{I} corresponding to the incorrect input character L_{I}[i] (S210). In some embodiments, if a key K_{L} corresponding to a character before or after the incorrect input character L_{I}[i] of the original character string str1 is adjacent to the key K_{I} corresponding to the incorrect input character L_{I}[i] on the software keyboard 13 (Y in S208), the key K_{I} corresponding to the incorrect input character L_{I}[i] is reduced. At this time, the key K_{L} which is adjacent to the key K_{I} and corresponds to the character before or after the incorrect input character L_{I}[i] is enlarged.

In the step S208, if the key K_{L} corresponding to the character before or after the incorrect input character L_{I}[i] of the original character string str1 is not adjacent to the key K_{I} corresponding to the incorrect input character L_{I}[i] on the software keyboard 13 (N in S208), the software keyboard 13 is not corrected.

If the incorrect input character L_{I}[i] and the correct input character L_{C}[i] are both null and the key K_{I} corresponding to the incorrect input character L_{I}[i] and the key K_{C} corresponding to the correct input character L_{C}[i] are adjacent to each other on the software keyboard 13 (Y in S212), the software keyboard 13 is corrected (S214). More specifically, the key K_{I} corresponding to the incorrect input character L_{I}[i] is reduced and the key K_{C} corresponding to the correct input character L_{C}[i] is enlarged.

The process of the correction executer 93 has been described in the above.

The configuration of the input device 2 has been described in the above. Next, an operation of the input device 2 will be described by way of some cases. In the following cases, it is assumed that a user intends to input a character string “hello”.

### (First Case)

If the user who intends to input the character string “hello” inputs “helo” by mistake, str1=“helo”, str2=“hello”, N1=4 and N2=5. In addition, L_{I}[0]=“Null”, L_{C}[0]=“l” and the number of incorrect input characters N3 is 1. The step S110 in FIG. 2 is subject to a correction method of the software keyboard 13.

Since L_{I}[0] is null, the step S202 in FIG. 3 moves to the step S204 where a key K_{C} corresponding to L_{C}[0]=“l” is enlarged. At this time, ambient keys K_{A} (for example, “k”, “;”, “o” and “,” are reduced together. The ambient keys K_{A} may be ones adjacent to the key K_{C} either horizontally/vertically or diagonally.

That is, in this case, since the key K_{C} corresponding to L_{C}[0] is small, it is estimated that a typographical error is highly likely to occur. By enlarging the key K_{C}=“l”, it is possible to decrease the probability of future typographical errors from occurring.

### (Second Case)

If the user who intends to input the character string “hello” inputs “hjello” by mistake, str1=“hjello”, str2=“hello”, N1=6 and N2=5. In addition, L_{I}[0]=“j”, L_{C}[0]=“Null” and the number of incorrect input characters N3 is 1. Also in this case, the step S110 in FIG. 2 is subject to a correction method of the software keyboard 13.

Since L_{I}[0] is non-null and L_{C}[0] is null, the step S206 in FIG. 3 moves to the step S208 where a key K_{I} corresponding to the character “h” in the original character string str1, which lies before the incorrect input character L_{I}[i]=“j”, is adjacent to a key K_{L} corresponding to the incorrect input character L_{I}[i] on the software keyboard 13 (Y in S208). Therefore, a key K_{C} corresponding to the incorrect input character L_{I}[i]=“j” is reduced. At this time, the key K_{L} adjacent to the key K_{C} and corresponding to the character “h” located before the incorrect input character L_{I}[i] is enlarged.

That is, in this case, the key “h” and the adjacent key “j” are highly likely to be input together by mistake. That is, it is determined that sensitivity of the key K_{C}=“j” is too high. By reducing the key K_{C}=“j”, it is possible to decrease the probability of future typographical errors from occurring.

### (Third Case)

If the user who intends to input the character string “hello” inputs “hrllo” by mistake, str1=“hrllo”, str2=“hello”, N1=5 and N2=5. In addition, L_{I}[0]=“r”, L_{C}[0]=“e” and the number of incorrect input characters N3 is 1. Also in this case, the step S110 in FIG. 2 is subject to a correction method of the software keyboard 13.

In this case, since the incorrect input character L_{I}[i] and the correct input character L_{C}[i] are both non-null (N in S206), the process proceeds to the step S212 where a key K_{I} corresponding to the incorrect input character L_{I}[i]=“r” and a key K_{C} corresponding to the correct input character L_{C}[i]=“e” are adjacent to each other on the software keyboard 13 (Y in S212). As a result, the key K_{I} corresponding to the incorrect input character L_{I}[i] is reduced and the key K_{C} corresponding to the correct input character L_{C}[i] is enlarged (S214).

That is, in this case, the user who intends to type the key K_{C}=“e” is highly likely to type the key K_{I}=“r”. By enlarging the size of the key K_{C} to increase its sensitivity and reducing the size of the key K_{I} to decrease its sensitivity, it is possible to prevent “e” from being input as “r” by mistake.

### (Fourth Case)

If the user who intends to input the character string “hello” inputs “hella” by mistake, str1=“hella”, str2=“hello”, N1=5 and N2=5. In addition, L_{I}[0]=“a”, L_{C}[0]=“o” and the number of incorrect input characters N3 is 1. Also in this case, the step S110 in FIG. 2 is subject to a correction method of the software keyboard 13.

In this case, since the incorrect input character L_{I}[i] and the correct input character L_{C}[i] are both non-null (N in S206), the process proceeds to the step S212 where a key K_{I} corresponding to the incorrect input character L_{I}[i]=“a” and a key K_{C} corresponding to the correct input character L_{C}[i]=“o” are not adjacent to each other on the keyboard (N in S212). As a result, the software keyboard 13 is not corrected.

That is, in this case, the user who intends to type the key K_{C}=“o” types the key K_{I}=“a” by mistake, which is most probably a human error independent of the keyboard layout. Therefore, through the step S212, it is possible to prevent performing the correction method of the software keyboard 13 based on the human error.

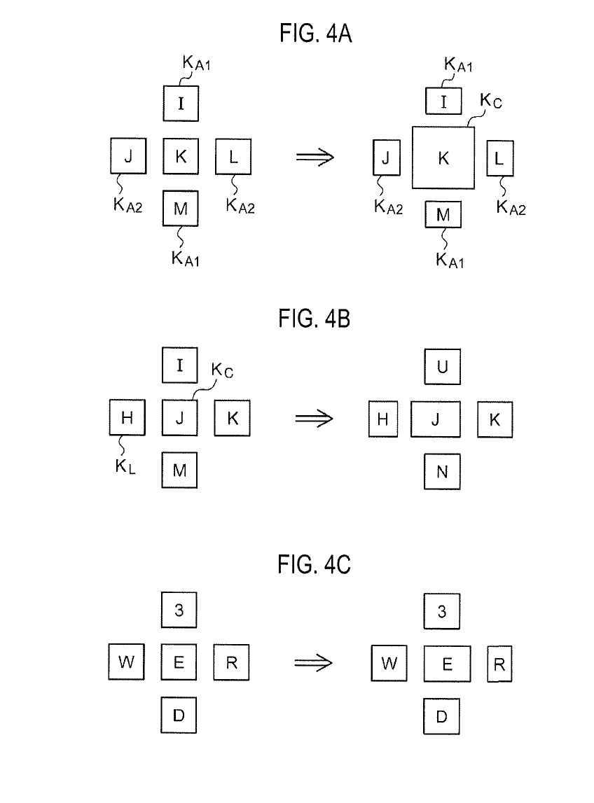

Next, a method of correcting the key size of the software keyboard 13 will be described in detail. FIGS. 4A to 4C are views showing states where keys are corrected in the steps S204, S210 and S214 in FIG. 3, respectively.

Referring to FIG. 4A, in the step S204, assuming that a key K_{C}=“k” is enlarged and ambient keys K_{A} (for example, “j”, “l”, “m” and “i”) are reduced, the key K_{C} is enlarged in the vertical and horizontal directions. On the other hand, keys K_{A1} adjacent to the key K_{C} in the vertical direction are reduced in the vertical direction and keys K_{A2} adjacent to the key K_{C} in the horizontal direction are reduced in the horizontal direction. For example, if K_{C} is enlarged by α%, K_{A} may be reduced by α%.

Referring to FIG. 4B, in the step S210, assuming that a key K_{C} corresponding to a correct input character L_{C}=“j” is enlarged and an adjacent key K_{L}=“h” is reduced, the key K_{C} is enlarged in a direction adjacent to the key K_{L}, that is, in the horizontal direction, and the key K_{L} is reduced in a direction adjacent to the key K_{C}, that is, in the horizontal direction. For example, if K_{C} is enlarged by α%, K_{L} may be reduced by α%.

Referring to FIG. 4C in the step S214, assuming that a key K_{C}=“e” corresponding to a correct input character L_{C} is enlarged and a key K_{L}=“r” corresponding to an incorrect input character L_{I} is reduced, the key K_{C} is enlarged in a direction adjacent to the key K_{I}, that is, in the horizontal direction, and the key K_{I} is reduced in a direction adjacent to the key K_{C}, that is, in the horizontal direction. For example, if K_{C} is enlarged by α%, K_{L} may be reduced by α%.

With the input device 2 according to the above embodiment, by detecting an incorrect input and correcting the software keyboard 13 in response to an error in a character string input by a user, it is possible to learn a user's hand size and finger length or a user's habit, and thereby optimizing an array of the software keyboard 13 adaptively and realize comfortable input environments.

Returning to FIG. 1, the keyboard correcting unit 90 of the input device 2 according to the input device 2 further includes a success rate calculator 94 which calculates a typing success rate. For example, the success rate calculator 94 may accumulate the total number of characters N1 or N2 and the number of incorrect characters N3 for a predetermined period of time and calculate a success rate S5 based on the ratio of an accumulative value.

The correction executer 93 compares success rates S5 before and after the correction of the software keyboard 13 and, if the success rate S5 is reduced by the correction of the software keyboard 13, returns the software keyboard 13 to have a layout before the correction. The success rate A5 before the correction of the software keyboard 13 may be an average of success rates obtained in the past.

In addition to the above-described correction function of the software keyboard 13, the input device 2 has an initial setting function, a user definition function and a macro function which will be described below.

### (Initial Setting Function)

As shown in FIG. 1, the input device 2 includes an initial setting unit 100 which performs an initialization sequence after the input device 2 is started or at any time and determines an initial layout of the software keyboard 13.

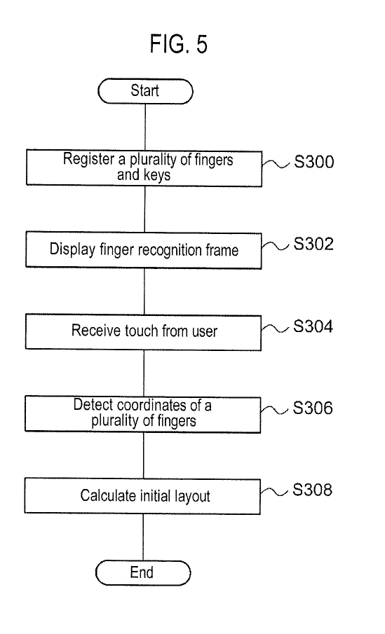

FIG. 5 is a flow chart of the initialization sequence of the software keyboard 13.

First, in left and right hands, a plurality of fingers used for the initial setting of the software keyboard 13 and a plurality of keys corresponding to the plurality of fingers are registered in response to an input from a user (S300). For example, for the left hand, the user can set three fingers, i.e., the thumb, the index finger and the index finger which are respectively assigned with “F”, “E” and “W”. For the right hand, the user can set three fingers, i.e., the thumb, the index finger and the middle finger which are respectively assigned with “J”, “I” and “O”. In some embodiments, any number of fingers may be assigned to keys.

Subsequently, the initial setting unit 100 displays a finger recognition frame 102 in a region where the software keyboard 13 of the display panel 12 of the display unit 10 is to be displayed (S302).

Then, the user is urged to touch the finger recognition frame 102 with a plurality of fingers, with the hands of the user aligned on the home position (S304). The initial setting unit 100 acquires coordinates of the plurality of fingers in the left and right hands with which the finger recognition frame 102 is touched (S306). Then, based on a relationship between the acquired finger coordinates and the keys assigned to the fingers, intervals between the keys and sizes of the keys are calculated and an initial arrangement of the software keyboard 13 is determined (S308).

FIG. 6A is a view showing the finger recognition frame 102, FIG. 6B is a view showing a state where the finger recognition frame 102 is touched by the user, and FIG. 6C is a view showing the software keyboard 13 calculated from finger coordinates.

As shown in FIG. 6C, in the step S308, coordinates of the thumbs, index fingers and middle fingers in the left and right hands are detected and positions and sizes of “F”, “E”, “W”, “J”, “I” and “O” keys are calculated based on the detected coordinates. In addition, a horizontal distance d1 between the thumb and the index finger, a horizontal distance d2 between the index finger and the middle finger and a vertical distance d3 between the thumb and the index finger can be obtained from the calculated coordinates. In addition, horizontal lengths of the keys and distances between keys adjacent to each other in the horizontal direction are calculated based on the left and right respective distances d1 and d2. In addition, vertical lengths of the keys and distances between keys adjacent to each other in the vertical direction are calculated based on the left and right respective distances d3. Thus, the size and arrangement of all keys constituting the software keyboard 13 are determined.

This initial setting function can determine a layout of the software keyboard 13 which may be most suitable for the user prior to performing the correction method of the software keyboard 13 through learning. When typing on a keyboard, user's preference for the initial layout of the software keyboard 13 such as which finger should be a reference for the home position and which key is typed with which finger is determined. Since this initial setting function allows the user to assign any key to any finger and determines the layout of the software keyboard 13 based on information obtained therefrom, the user is not restricted to a specific position and it is possible to provide the user with more comfortable input environments.

### (Customization Function)

As shown in FIG. 1, the input device 2 includes a user definition unit 110 which receives a user input designating any two keys from the user to change assignments associated with them. For example, if a key K1 assigned to a character L1 and a key K2 assigned to another character L2 are designated, a code C1 of the key K1 is assigned to the character L2 and a code C2 of the key K2 is assigned to the character L1.

A method of designating two keys is not particularly limited. For example, the user may type two keys K1 and K2 in turn or drag one key K1 onto a position of another key K2.

The layout data S2 in the memory 52 is updated based on the information related to the change of the assignments associated with the keys K1 and K2. The keyboard displaying unit 50 displays the software keyboard 13 on the display panel 12 based on the updated layout data S2. For example, if the user wish to switch the key assigned to “Shift” with a key assigned to “Function”, the software keyboard 13 displayed on the display panel 12 displays the key K1 as “Func” and the key K2 as “Shift”.

When two keys are switched, only characters that are input while a “Shift” key or a “Numlock” key is pressed may be switched.

This customization function may customize the software keyboard 13 according to user's preference.

### (Macro Function)

As shown in FIG. 1, the input device 2 includes a macro unit 120 which receives macro information including a combination of a designated character string str3 and a key K1 corresponding to the designated character string str3 from the user. A method of inputting the macro information is not particularly limited. It is assumed that the character string str3 is input when the key K1 is pressed. The macro information is provided to the input determining unit 70.

It is assumed that the key K1 may be a key having the low frequency of use by the user, for example, one of keys “/”, “-” and “=” rather than the functional keys “F1” to “F10” without being particularly limited thereto. For example, if a character string str3 “000” is assigned to a key K1 “/”, the input determining unit 70 determines that “000” is input when the user presses the key “/”.

The macro function can effectively utilize keys having the low use frequency.

Some embodiments of the present disclosure have been described in the above. However, these embodiments are only for illustrative purposes and it is to be understood to those skilled in the art that various modifications to combinations of elements or steps of the embodiments may be made without departing from the scope of the present disclosure, as will be described below.

### (Modification 1)

The three correcting steps S204, S210 and S214 have been shown and illustrated in the flow chart of FIG. 3 and the above embodiments but the present disclosure is not limited thereto. For example, only one or two steps of the three correcting steps S204, S210 and S214 may be employed. Alternatively, correcting steps other than the three illustrated correcting steps S204, S210 and S214 may be performed.

### (Modification 2)

The correction executer 93 may correct positions of the keys instead of or in addition to the above-described sizes of the keys. For example, when a key corresponding to a correct input character is adjacent to a key corresponding to an incorrect input character, the correction executer 93 may shift the key corresponding to the correct input character toward the key corresponding to the incorrect input character.

The above-described modifications can achieve the same advantages as the above embodiments.

According to the present disclosure in some embodiments, it is possible to provide the user with more comfortable input environments.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An input method using a software keyboard, comprising:
displaying a software keyboard on a display device having a touch panel;
monitoring an input from a user and detecting a sequence including an input of an original character string, a command to delete at least one character from the original character string and a re-input of a new character string;
acquiring at least one of an incorrect input character contained in the original character string and a corresponding correct input character contained in the new character string by comparing the original character string and the new character string; and
correcting the software keyboard based on the acquired at least one of the incorrect input character and the correct input character.

2. The input method of claim 1, wherein the act of correcting the software keyboard includes correcting a size of at least one key of the software keyboard.

3. The input method of claim 2, wherein the act of correcting the size of at least one key includes enlarging the size of a key corresponding to the correct input character.

4. The input method of claim 2, wherein the act of correcting the size of at least one key includes reducing the size of a key corresponding to the incorrect input character.

5. The input method of claim 2, wherein the act of correcting the size of at least one key includes enlarging the size of a key corresponding to the correct input character if the incorrect input character is null and the correct input character is a character.

6. The input method of claim 2, wherein the act of correcting the size of at least one key includes reducing the size of a key corresponding to the incorrect input character if the incorrect input character is a character and the correct input character is null.

7. The input method of claim 6, wherein the act of correcting the size of at least one key includes reducing the size of the key corresponding to the incorrect input character if a key corresponding to a character located before or after the incorrect input character of the original character string is adjacent to the key corresponding to the incorrect input character on the software keyboard.

8. The input method of claim 1, wherein the act of correcting the software keyboard includes correcting the software keyboard if the key corresponding to the incorrect input character and the key corresponding to the correct input character are both characters and are adjacent to each other on the software keyboard.

9. The input method of claim 8, wherein the act of correcting the software keyboard includes reducing the size of the key corresponding to the incorrect input character and enlarging the size of the key corresponding to the correct input character.

10. The input method of claim 1, wherein the act of correcting the software keyboard includes correcting a position of at least one key of the software keyboard.

11. The input method of claim 10, wherein the act of correcting the position of at least one key of the software keyboard includes shifting the key corresponding to the correct input character toward the key corresponding to the incorrect input character.

12. The input method of claim 1, further comprising:
calculating a typing success rate; and
restoring the software keyboard to a state before the correction of the software keyboard if the success rate is decreased after the software keyboard is corrected.

13. The input method of claim 1, further comprising:
registering a plurality of fingers used for initial setting of the software keyboard in the left and right hands and a plurality of keys corresponding to the plurality of fingers, based on an input from the user;
displaying a finger recognition frame in a region where the software keyboard of the display device is to be displayed;
urging for the user to touch the finger recognition frame with the plurality of fingers in a state where the hands of the user are aligned on the home position of the user and detecting coordinates of the plurality of fingers touched by the user; and
determining an initial arrangement of the software keyboard based on the coordinates of the plurality of fingers touched by the user.

14. The input method of claim 1, further comprising customizing the software keyboard to switch any two keys designated by the user.

15. The input method of claim 1, further comprising assigning any character string designated by the user to a corresponding key.

16. An input device using a software keyboard, comprising:
a display device having a touch panel;
a coordinate detecting unit configured to generate coordinate data indicating positions on the touch panel touched by a user;
a keyboard displaying unit configured to display a software keyboard on the display device;
an input determining unit configured to generate a code in response to a key touched by the user based on layout information of the software keyboard currently displayed on the display device and the coordinate data; and
a keyboard correcting unit configured to correct the software keyboard by monitoring the code,
wherein the keyboard correcting unit includes:
a re-input detector configured to monitor the code and detect a sequence including input of an original character string, a command to delete at least one character of the original character string and a re-input of a new character string;
an incorrect input character estimator configured to acquire at least one of an incorrect input character contained in the original character string and a corresponding correct input character contained in the new character string by comparing the original character string and the new character string; and
a correction executer configured to correct the software keyboard based on the acquired at least one of the incorrect input character and the correct input character.

17. The input device of claim 16, wherein the correction executer corrects a size of at least one key of the software keyboard.

18. The input device of claim 17, wherein the correction executer enlarges the size of a key corresponding to the correct input character.

19. The input device of claim 17, wherein the correction executer reduces the size of a key corresponding to the incorrect input character.

20. The input device of claim 17, wherein the correction executer enlarges the size of a key corresponding to the correct input character if the incorrect input character is null and the correct input character is a character.

21. The input device of claim 17, wherein the correction executer enlarges the size of a key corresponding to the incorrect input character if the incorrect input character is a character and the correct input character is null.

22. The input device of claim 21, wherein the correction executer reduce the size of the key corresponding to the incorrect input character if a key corresponding to a character located before or after the incorrect input character of the original character string is adjacent to the key corresponding to the incorrect input character on the software keyboard.

23. The input device of claim 16, wherein the correction executer corrects the software keyboard if the key corresponding to the incorrect input character and the key corresponding to the correct input character are both characters and are adjacent to each other on the software keyboard.

24. The input device of claim 23, wherein the correction executer reduces the size of the key corresponding to the incorrect input character and enlarges the size of the key corresponding to the correct input character.

25. The input device of any one of claim 16, wherein the correction executer corrects a position of at least one key of the software keyboard.

26. The input device of claim 25, wherein the correction executer shifts the key corresponding to the correct input character toward the key corresponding to the incorrect input character.

27. The input device of claim 16, wherein the keyboard correcting unit further includes: a success rate calculator configured to calculate a typing success rate, and
wherein the correction executer restores the software keyboard to a state before the correction of the software keyboard if the success rate is decreased after the software keyboard is corrected.

28. The input device of claim 16, further comprising an initial setting unit configured to perform initial setting of the keyboard,
wherein the initial setting unit performs a sequence including:
registering a plurality of fingers used for initial setting of the software keyboard in the left and right hands and a plurality of keys corresponding to the plurality of fingers, based on an input from the user;
displaying a finger recognition frame in a region where the software keyboard of the display device is to be displayed;
urging for the user to touch the finger recognition frame with the plurality of fingers in a state where the hands of the user are aligned on the home position of the user and detecting coordinates of the plurality of fingers touched by the user; and
determining an initial arrangement of the software keyboard based on the coordinates of the plurality of fingers touched by the user.

29. The input device of claim 16, further comprising a customization unit configured to switch any two keys designated by the user.

30. The input device of claim 16, further comprising a macro unit configured to assign any character string designated by the user to a corresponding key.

31. An electronic apparatus comprising an input device of claim 16.
